(19) United States
(12) Patent Application Publication
(10) Pub. No.: US 2019/0146926 A1
(43) Pub. Date: May 16, 2019

(54) STORAGE DEVICE AND OPERATING METHOD OF STORAGE DEVICE

(71) Applicant: SAMSUNG ELECTRONICS CO., LTD., Suwon-si (KR)

(72) Inventors: SEHWAN LEE, SEOUL (KR); HYUN JIN CHOI, SUWON-SI (KR)

(21) Appl. No.: 16/012,808

(22) Filed: Jun. 20, 2018

(30) Foreign Application Priority Data
Nov. 14, 2017 (KR) 10-2017-0151646

(51) Int. Cl. G06F 12/10

(52) U.S. Cl. CPC G06F 12/10

(57) ABSTRACT

A storage device includes a memory device and a controller that translates a logical address received from a host into a physical address for the memory device. The controller manages correspondence information indicating a correspondence relationship between logical addresses and physical addresses and a mapping function for determining a mapping unit corresponding to the received logical address in a partial memory area on the memory device indicated by a physical address managed in the correspondence information. The mapping unit corresponding to the received logical address is an area on the memory device indicated by the received logical address. The controller determines the partial memory area including the mapping unit corresponding to the received logical address with reference to the correspondence information and determines the mapping unit from the partial memory area by using the mapping function.

### CROSS-REFERENCE TO RELATED APPLICATIONS

This application claims priority under 35 U.S.C. § 119 to Korean Patent Application No. 10-2017-0151646 filed Nov. 14, 2017, in the Korean Intellectual Property Office, the disclosure of which is incorporated by reference herein in its entirety.

### BACKGROUND

Embodiments of the disclosure described herein relate to an electronic device, and more particularly, relate to a storage device for storing and managing data and an operation of the storage device.

In recent years, various kinds of electronic devices have been used.

The electronic device performs a unique function based on operations of various electronic circuits included therein. A storage device is an example of electronic devices. The storage device includes a memory device for storing data. The memory device stores or outputs data, and thus, the storage device provides a user with a storage service.

The memory device includes a plurality of memory locations for storing data. Memory locations are recognized and indicated based on values called “addresses”. In the memory device, data are stored at a memory location indicated by an address or are output from a memory location indicated by an address. The storage device may appropriately manage an address for the purpose of controlling the memory device.

An address processed by a host device that is placed outside the storage device may be different from an address indicating a memory location in the memory device. Accordingly, the storage device may perform address translation, for example, address mapping between an address processed by the host device and an address for the memory device.

### SUMMARY

Embodiments of the disclosure provide a storage device configured to perform address translation between a logical address processed by a host and a physical address for a memory device.

The technical problem to be solved by embodiments of the disclosure is not limited to the above-described technical problems, and other technical problems can be deduced from the following embodiments.

According to an exemplary embodiment, a storage device may include a memory device, and a controller that translates a logical address received from a host into a physical address for the memory device. The controller may manage correspondence information indicating a correspondence relationship between logical addresses and physical addresses and a mapping function for determining a mapping unit corresponding to the received logical address in a partial memory area on the memory device indicated by a physical address managed in the correspondence information. The mapping unit corresponding to the received logical address may be an area on the memory device indicated by the received logical address. The controller may determine the partial memory area including the mapping unit corresponding to the received logical address with reference to the correspondence information and may determine the mapping unit from the partial memory area by using the mapping function.

According to an exemplary embodiment, a method for operating a storage device may include obtaining a physical address corresponding to a logical address received from a host, based on correspondence information indicating a correspondence relationship between logical addresses and physical addresses, determining a mapping unit corresponding to the received logical address in a partial memory area on a memory device indicated by the obtained physical address, by using a mapping function, and reading or writing data from or in the determined mapping unit. The mapping unit corresponding to the received logical address may be included in the partial memory area.

According to an exemplary embodiment, a storage device may include a memory device, and a controller that translates a logical address received from a host into a physical address for the memory device. The controller may manage correspondence information indicating a correspondence relationship between logical addresses and physical addresses and a mapping function for determining a mapping unit corresponding to the received logical address in a partial memory area on the memory device indicated by a physical address managed in the correspondence information. The number of bits of a physical address managed in the correspondence information is smaller than the number of bits of a physical address indicating the mapping unit, as much as “M” (M being a positive integer). The partial memory area on the memory device indicated by the physical address managed in the correspondence information may include 2^{M} mapping units, and the controller may use the mapping function to determine one mapping unit of the 2^{M} mapping units as the mapping unit corresponding to the received logical address.

According to an exemplary embodiment, a storage device includes a memory and a controller. The memory has memory blocks, each of the memory blocks includes pages, each of the pages includes mapping units, each of the pages is uniquely identified by a value of a first portion of an address, and each of the mapping units is uniquely identified by the value of the first portion of the address and a value of a second portion of the address. The controller identifies a first memory block, among the memory blocks, having fewer valid mapping units addressed by a same value of the second portion of the address than available mapping units addressed by the value of the second portion of the address in a second memory block among the memory blocks. Also, the controller copies data from all valid mapping units within the first memory block to the second memory block.

According to an exemplary embodiment, a storage device includes a memory and a controller. The controller: (1) receives a first address from an external host, (2) identifies a first portion of a second address that corresponds to the first address, (3) generates a second portion of the second address from the first portion of the second address using a mathematical function, and (4) accesses a storage area of the memory identified by the first and second portions of the second address. Neither the first portion of the second address nor the second portion of the second address uniquely identifies the storage area.

### BRIEF DESCRIPTION OF THE FIGURES

The above and other objects and features of the disclosure will become apparent by describing in detail exemplary embodiments thereof with reference to the accompanying drawings.

FIG. 1 illustrates a block diagram of an electronic device according to an embodiment.

FIG. 2 is a conceptual diagram for describing address translation performed in a storage device according to an embodiment.

FIG. 3 illustrates mapping information according to an embodiment.

FIG. 4 is a conceptual diagram for describing a mapping unit according to an embodiment.

FIG. 5 is a conceptual diagram indicating the process of translating a logical address into a physical address, according to an embodiment.

FIG. 6A illustrates a state where data are stored in a block, according to an embodiment.

FIG. 6B is a conceptual diagram indicating the number of valid mapping units for each bucket of a block illustrated in FIG. 6A.

FIG. 7A illustrates data store states of a source block and a destination block according to an embodiment.

FIG. 7B indicates states of a source block and a destination block after data migration from the source block to the destination block of FIG. 7A is made.

FIG. 8A illustrates data store states of a source block and a destination block according to another embodiment.

FIG. 8B indicates states of a source block and a destination block after data migration from the source block to the destination block of FIG. 8A is made.

FIG. 9A illustrates data store states of a source block and a destination block according to another embodiment.

FIG. 9B indicates states of a source block and a destination block after data migration from the source block to the destination block of FIG. 9A is made.

FIG. 10 illustrates a flowchart of a method for operating the storage device according to an embodiment.

FIG. 11 illustrates a flowchart of a method for operating the storage device according to an embodiment.

FIG. 12 is a block diagram illustrating an exemplary configuration of an electronic system including the storage device according to an embodiment.

### DETAILED DESCRIPTION

Below, embodiments of the disclosure will be described in detail and clearly to such an extent that those (hereinafter referred to as “ordinary those”) skilled in the art easily implement the disclosure.

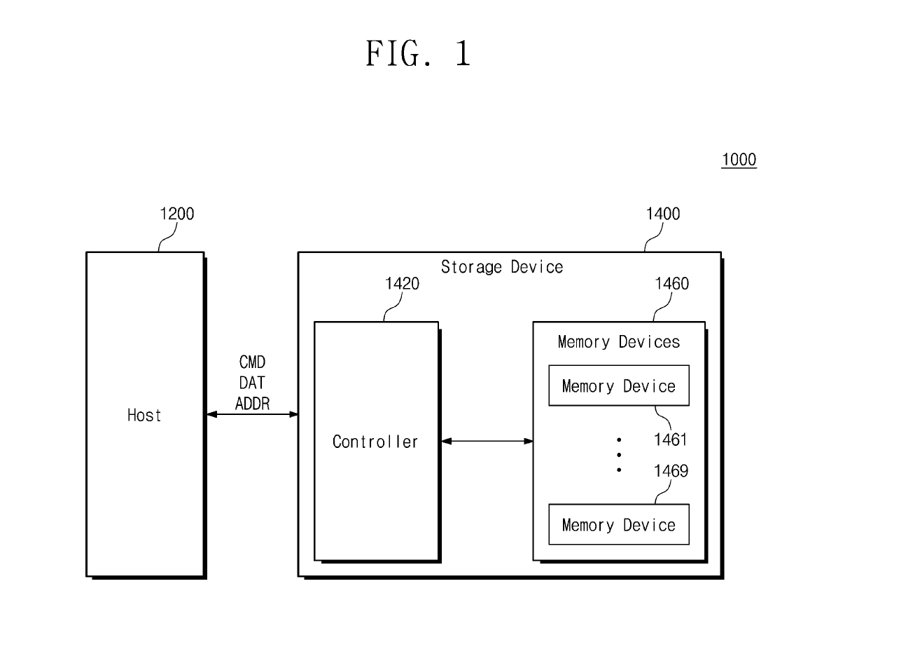

FIG. 1 illustrates a block diagram of an electronic device according to an embodiment.

An electronic device 1000 may store data, may manage the stored data, and may provide necessary information to a user. The electronic device 1000 may be a personal computer or a mobile electronic device such as a notebook computer, a mobile phone, a personal digital assistant (PDA), or a camera. However, embodiments may not be limited thereto.

The electronic device 1000 may include a host 1200 and a storage device 1400. The host 1200 and the storage device 1400 may manage data while communicating with each other. For example, the host 1200 may request data from the storage device 1400 or may instruct the storage device 1400 to store data.

The host 1200 may provide various services to the user of the host 1200 depending on operations of one or more electronic circuits/chips/devices. The host 1200 may perform various operations for the purpose of processing an instruction received from the user of the host 1200 and may provide the operation result(s) to the user of the host 1200. The host 1200 according to an embodiment may include an operating system, an application, and the like. The host 1200 according to an embodiment may include, but is not limited to, an operation processor (e.g., a central processing unit (CPU), a graphic processing unit (GPU), an application processor (AP), and the like) including dedicated logic circuits (e.g., a field programmable gate array (FPGA), application specific integrated circuits (ASICs), and the like).

The host 1200 according to an embodiment may be an electronic device that is independent of the storage device 1400. For example, the host 1200 may be any one of various user devices such as a mobile communication terminal, a desktop computer, a notebook computer, a tablet computer, a smartphone, a wearable device, and the like. Alternatively, the host 1200 may be any one of a workstation, another server, or a vehicle.

The host 1200 according to an embodiment may be included in a single electronic device together with the storage device 1400. In this example, the host 1200 may be the operation processor itself.

The storage device 1400 may include a controller 1420 and memory devices 1460. It is assumed that the memory devices 1460 according to an embodiment include memory devices 1461 and 1469.

The controller 1420 may control overall operations of the storage device 1400. For example, the controller 1420 may schedule operations of the memory devices 1461 and 1469 or may encode and decode signals/data to be processed in the storage device 1400. For example, the controller 1420 may control the memory devices 1461 and 1469 to allow the memory devices 1461 and 1469 to store or output data.

The controller 1420 may be connected with the memory devices 1460 through a plurality of channels. The controller 1420 may include a hardware or software device (not illustrated) for performing an operation in response to various requests from the host 1200. The controller 1420 according to an embodiment may include a volatile memory such as a dynamic random access memory (DRAM), a static random access memory (SRAM), or a synchronous DRAM (SDRAM).

The controller 1420 may include one or more hardware components (e.g., an analog circuit, a logic circuit, and the like) that are configured to perform functions described above and to be described below. Additionally, or alternatively, the controller 1420 may include one or more processor cores. Functions of the controller 1420 that are described above and to be described below may be implemented with a program code of software and/or firmware, and a processor core or multiple cores of the controller 1420 may execute an instruction set of the program code. The processor core(s) of the controller 1420 may process various kinds of arithmetic operations and/or logical operations for the purpose of executing the instruction set.

The memory devices 1460 may include at least one non-volatile memory. For example, the memory devices 1460 may include a plurality of flash memories. For example, the memory devices 1460 may include different types of non-volatile memories such as a phase-change RAM (PRAM), a ferrroelectric RAM (FRAM), or a magneto-resistive RAM (MRAM). The memory devices 1460 may store one data bit or two or more data bits per memory cell. Also, the non-volatile memory constituting the memory devices 1460 may include a memory cell array of a three-dimensional structure. However, embodiments may not be limited thereto. For example, the storage device 1400 may include any type of memory device for storing data.

According to an embodiment, each of the memory devices 1461 and 1469 may be a non-volatile memory. Each of the memory devices 1461 and 1469 may include memory locations for storing data. Here, a memory location is recognized and indicated based on a value called an “address”. Write data may be stored at a memory location indicated by an address, and read data may be output from a memory location indicated by an address. According to an embodiment, one memory area may include a plurality of memory locations that are respectively indicated by a plurality of addresses.

The memory devices 1460 may include a plurality of memory banks connected through a plurality of channels, and each of the plurality of memory banks may include a plurality of memory chips. Each of the plurality of memory chips may include a plurality of memory blocks, each of which includes a plurality of memory pages.

Each of the plurality of memory pages may include a plurality of mapping units. According to an embodiment, a memory location indicated by an address may mean a location of a mapping unit. The mapping unit may mean a memory location or a memory area on the memory devices 1460, which is finally to be indicated by an address.

To exchange data DAT associated with a specific memory location or a specific memory area of the memory devices 1461 and 1469, the host 1200 may provide an address ADDR to the storage device 1400. The storage device 1400 may control the memory devices 1461 and 1469 based on a request (e.g., a command CMD) and an address ADDR received from the host 1200.

Meanwhile, the address ADDR processed by the host 1200 may be different from an address indicating a memory location in the memory devices 1461 and 1469. For example, the address ADDR processed by the host 1200 may be called a “logical address”, and an address for the memory devices 1461 and 1469 may be called a “physical address”. To appropriately control the memory devices 1461 and 1469, the storage device 1400 may perform address translation between a logical address processed by the host 1200 and a physical address for the memory devices 1461 and 1469.

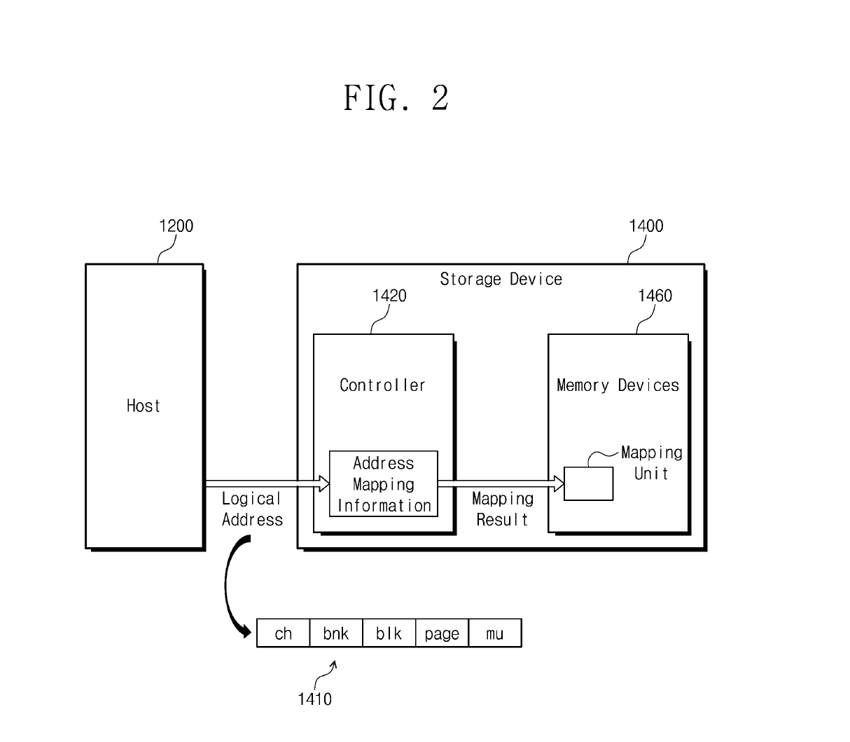

FIG. 2 is a conceptual diagram for describing address translation performed in a storage device according to an embodiment.

The controller 1420 may perform address translation between a logical address and a physical address. For example, the controller 1420 may translate a logical address received from the host 1200 into a physical address for the memory devices 1460. Accordingly, even though a logical address provided from the host 1200 is different from a physical address indicating a specific memory location on the memory devices 1460, the controller 1420 may control the memory devices 1460 based on the translated physical address.

The logical address 1410 indicates an example of a configuration of a logical address capable of being received from the host 1200. For example, the logical address 1410 may be formed of an area “ch” for indicating a channel in the memory devices 1460, an area “bnk” for indicating a bank, an area “blk” for indicating a block, an area “page” for indicating a page, and an area “mu” for indicating a mapping unit. According to an embodiment, an upper bit of the logical address 1410 may indicate information for specifying a channel, and a lower bit thereof may indicate information for specifying a mapping unit.

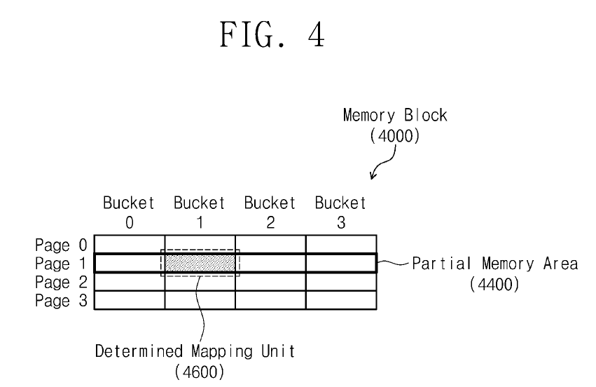

For example, the host 1200 may send a write or read command to the storage device 1400 together with the logical address 1410. The controller 1420 may determine one mapping unit on the memory devices 1460 corresponding to the received logical address 1410. The storage device 1400 may write data in a mapping unit on the memory devices 1460 corresponding to the logical address 1410 and may read data from a mapping unit. The mapping unit that is an area on the memory devices 1460 indicated by a logical address will be more fully described with reference to FIG. 4.

To perform the address translation, the controller 1420 may manage address mapping information. The mapping information may include metadata that are referenced to perform the address translation between a logical address and a physical address. The mapping information according to an embodiment may include correspondence information indicating a correspondence relationship between logical addresses and physical addresses and a mapping function capable of outputting information (e.g., a mapping result) about a location of a mapping unit.

According to an embodiment, the mapping information may be managed in a volatile memory connected with the controller 1420. Alternatively, the mapping information may be stored in a cache memory in the controller 1420 or on the memory devices 1460. In some cases, the mapping information may be distributed to and stored in a volatile memory connected with the controller 1420, a cache memory of the controller 1420, and at least one of the memory devices 1460. To perform the address translation, the controller 1420 may access a memory that stores mapping information.

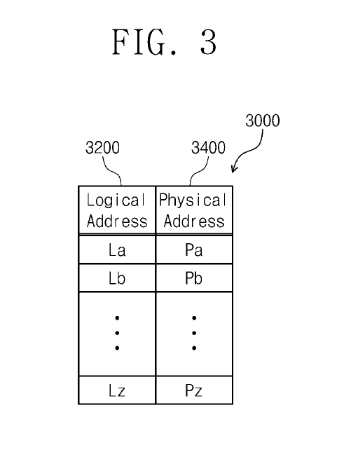

FIG. 3 indicates correspondence information indicating a correspondence relationship between logical addresses and physical addresses according to an embodiment.

The controller 1420 according to an embodiment may manage correspondence information indicating a correspondence relationship between logical addresses and physical addresses.

For example, the controller 1420 of FIG. 2 may manage a mapping table 3000 as correspondence information. The mapping table 3000 may include information about a correspondence relationship between logical addresses La to Lz and physical addresses Pa to Pz. The mapping table 3000 according to an embodiment may be implemented in the form of a look-up table. The controller 1420 may translate a logical address into a corresponding physical address with reference to the mapping table 3000.

For example, the logical address La may correspond to the physical address Pa. In the case where the controller 1420 receives the logical address La from the host 1200 of FIG. 2, the controller 1420 may map the logical address La onto the physical address Pa. Accordingly, the controller 1420 may process a request received from the host 1200 together with the logical address La, in connection with a memory location (e.g., a page and a mapping unit) indicated by the physical address Pa.

For example, a column 3200 may include information about a logical address, and a column 3400 may include information about a physical address. Physical addresses managed in the column 3400 may indicate a partial memory area in the memory devices 1460. For example, the controller 1420 may obtain a physical address corresponding to the received logical address with reference to the mapping table 3000 and may access a page or a mapping unit on the memory devices 1460 based on the obtained physical address.

The mapping table 3000 according to an embodiment may be a full mapping table (FMT). The full mapping table FMT may be used to fully manage the physical addresses Pa to Pz on the memory devices 1460 of FIG. 2. For example, the physical addresses Pa to Pz managed in the full mapping table FMT may fully cover all memory areas on the memory devices 1460 and may indicate all memory areas. In this embodiment, when the controller 1420 receives any logical address from the host 1200, the controller 1420 may map the received logical address onto a physical address corresponding to the received logical address, with reference to the full mapping table FMT. The controller 1420 may directly map the received logical address onto one mapping unit in the memory devices 1460, with reference to the mapping table 3000.

However, in the case where a capacity of the memory devices 1460 increases, the amount of physical addresses to be managed in connection with the memory devices 1460 may also increase. An increase in the amount of physical addresses may cause an increase in the size of the mapping table 3000. If the size of the mapping table 3000 increases, there may be a need for additional allocation of a resource (e.g., a buffer memory connected with the controller 1420, a cache memory in the controller 1420, the memory devices 1460, or the like) in the storage device 1400 of FIG. 2. Accordingly, the mapping table 3000 implemented with the full mapping table FMT may make the efficiency of managing the storage device 1400 low.

Accordingly, a physical address managed in the mapping table 3000 may be managed to have a size smaller than a size of a physical address managed in a full mapping table. For example, in the case where the size of a physical address needed to indicate a mapping unit on the memory devices 1460 is “N” bits (N being a positive integer), a physical address managed in the mapping table 3000 may have the size of “N−M” bits (M being a positive integer smaller than N). A final location of a mapping unit corresponding to the received logical address may be determined by a mapping function to be described later.

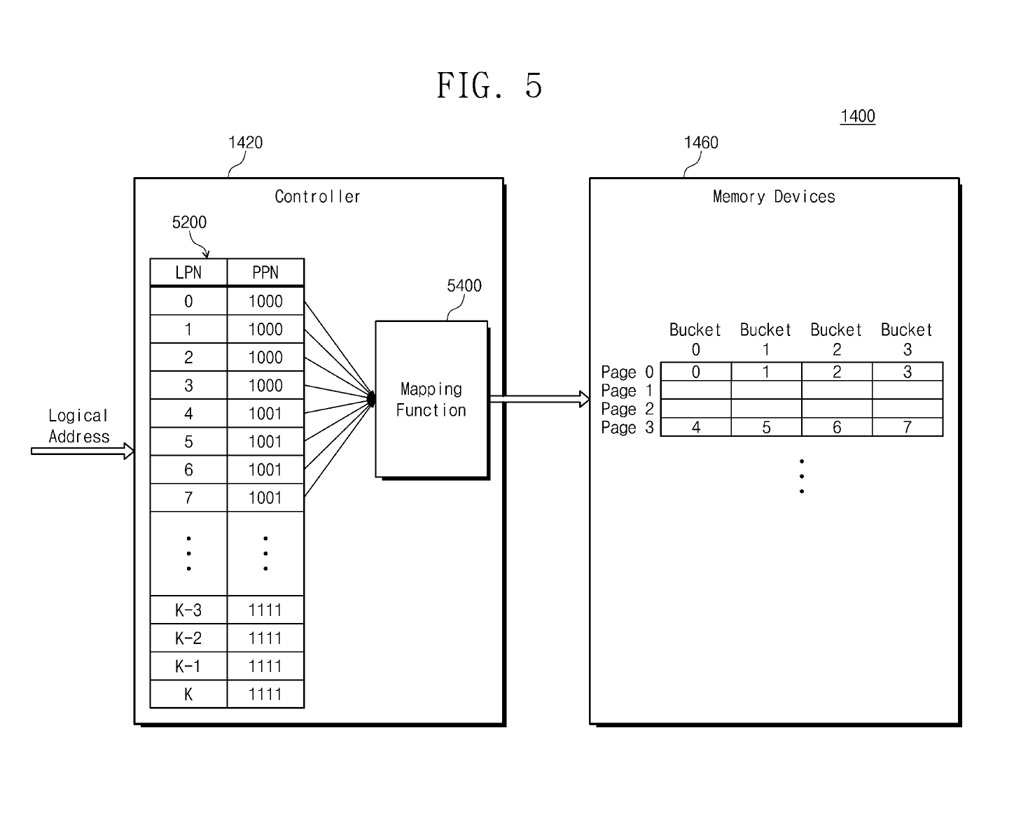

Accordingly, there may be a decrease in a memory area of the controller 1420 that is occupied by correspondence information 5200 (refer to FIG. 5) indicating a correspondence relationship between logical addresses and physical addresses. Memory that is freed by a decrease of the correspondence information 5200 may be used as a buffer memory for improving the performance of the storage device 1400 or may be used to store parity information for improving the reliability of data.

FIG. 4 is a conceptual diagram for describing a mapping unit according to an embodiment.

A mapping unit may mean an area on a memory indicated by a logical address. For example, the mapping unit may mean an area of a minimum unit on a memory indicated by a logical address.

A memory block 4000 (hereinafter referred to as a “block”) according to an embodiment may indicate one block of a plurality of memory blocks included in any one memory device of the memory devices 1461 and 1469 included in the memory devices 1460 of FIG. 2.

The block 4000 may be composed of a plurality of pages, each of which includes a plurality of mapping units. For convenience of description, it is assumed that the block 4000 is composed of four pages Page 0, Page 1, Page 2, and Page 3, each of which includes four mapping units. In this embodiment, 16 mapping units may be present in the block 4000.

The controller 1420 may determine a mapping unit 4600 corresponding to a received logical address. For example, the host 1200 may send a write command for data to the storage device 1400 together with a logical address, and the storage device 1400 may determine the mapping unit 4600 corresponding to the received logical address and may write the data in the determined mapping unit 4600.

A partial memory area 4400 may mean one area on the memory devices 1460. The partial memory area 4400 may mean an area indicated by a physical address that is obtained with reference to correspondence information indicating a correspondence relationship between logical addresses and physical addresses. For example, the partial memory area 4400 may mean an area of the block 4000, in which page 1 is placed.

As described later, a location of a mapping unit that is finally indicated by a logical address received from the host 1200 may be determined by using a mapping function. For example, information for determining a location of the mapping unit 4600 corresponding to the received logical address in the partial memory area 4400 may be output from the mapping function.

The block 4000 may be divided into buckets that are virtual areas. The block 4000 may be divided into a plurality of buckets based on the information output from the mapping function. Each of the plurality of buckets may correspond to an area that each of a plurality of information output from the mapping function indicates.

For example, in the case where the mapping function outputs information for determining one mapping unit of 2^{M} mapping units, the block 4000 may be divided into 2^{M} buckets. That is, in the case where information output from the mapping function for the purpose of determining a location of a mapping unit corresponding to a received logical address is any one of 0th location information, first location information, second location information, and third location information, the block 4000 may be divided into bucket #0 corresponding to an area in the block 4000 capable of being indicated by the 0th location information, bucket #1 corresponding to an area in the block 4000 capable of being indicated by the first location information, bucket #2 corresponding to an area in the block 4000 capable of being indicated by the second location information, and bucket #3 corresponding to an area in the block 4000 capable of being indicated by the third location information. Each of the buckets may include four mapping units.

For example, in the case where information output from the mapping function is a bit value “00”, the controller 1420 may determine that a mapping unit corresponding to a received logical address is placed at the 0th column in the block 4000. In the case where information output from the mapping function is a bit value “01”, the controller 1420 may determine that a mapping unit corresponding to a received logical address is placed at the first column in the block 4000. In the case where information output from the mapping function is a bit value “10”, the controller 1420 may determine that a mapping unit corresponding to a received logical address is placed at the second column in the block 4000. In the case where information output from the mapping function is a bit value “11”, the controller 1420 may determine that a mapping unit corresponding to a received logical address is placed at the third column in the block 4000. In this embodiment, the controller 1420 may determine that the 0th column of the block 4000 corresponds to bucket #0, that the first column of the block 4000 corresponds to bucket #1, that the second column of the block 4000 corresponds to bucket #2, and that the third column of the block 4000 corresponds to bucket #3.

Accordingly, the controller 1420 according to an embodiment may obtain a physical address corresponding to a received logical address by using the correspondence information and may determine the partial memory area 4400 indicated by the obtained physical address. Afterwards, the controller 1420 may determine that the mapping unit 4600 corresponding to the received logical address is placed at bucket #1 in the partial memory area 4400, with reference to information output from the mapping function.

FIG. 5 is a conceptual diagram indicating the process of translating a logical address into a physical address, according to an embodiment.

The controller 1420 according to an embodiment may manage the correspondence information 5200 and a mapping function 5400 as mapping information for the purpose of determining a mapping unit corresponding to a logical address.

The correspondence information 5200 may indicate a correspondence relationship between logical addresses and physical addresses. For example, the correspondence information 5200 may be managed to include logical addresses LPN at the left column and physical addresses PPN respectively corresponding to the logical addresses at the right column. The correspondence information 5200 according to an embodiment may be stored in a buffer memory connected with the controller 1420, a cache memory in the controller 1420, and the memory devices 1460.

A physical address managed in the correspondence information 5200 may be managed to have a size smaller than a size of a physical address managed in the full mapping table. For example, in the case where the size of a physical address needed to indicate a mapping unit is “N” bits (N being a positive integer), a physical address managed in the correspondence information 5200 may have the size of “N−M” bits (M being a positive integer smaller than N). Here, “M” may be differently determined according to the degree for reducing a memory that the correspondence information 5200 occupies. As an embodiment, “M” may be a value that is determined in a design or manufacturing step of the storage device 1400 in consideration of a capacity of a buffer memory connected with the controller 1420, a cache memory in the controller 1420, and the memory devices 1460. As another embodiment, “M” may be a value that flexibly varies with a state of the storage device 1400. For example, “M” may be determined to be small if a buffer memory or a cache memory in the storage device 1400 is sufficient and may be determined to be great if not.

In the case where one block includes 2^{K} pages (K being a positive integer), “M” may be determined to be a value smaller than “K” because of the following cause. If “M” is the same as “K”, a physical address managed in the correspondence information 5200 may indicate a block itself, and thus, complexity of the mapping function and workload may increase.

For example, in the case where the number of bits of a physical address needed to indicate a location of one mapping unit is “6”, the correspondence information 5200 may manage a 4-bit physical address. The controller 1420 may obtain a physical address corresponding to the received logical address with reference to the correspondence information 5200. However, since a physical address obtained from the correspondence information 5200 is able to indicate only a partial memory area (e.g., the partial memory area 4400 of FIG. 4) in the memory devices 1460, the controller 1420 cannot determine a final location of a mapping unit only by using the obtained physical address.

The controller 1420 may obtain a physical address “1000” corresponding to logical addresses LPN 0, LPN 1, LPN 2, and LPN3 with reference to the correspondence information 5200 and may determine that mapping units respectively corresponding to the logical addresses LPN 0, LPN 1, LPN 2, and LPN3 are placed at page 0, based on the obtained physical address “1000”. The controller 1420 may obtain a physical address “1001” corresponding to logical addresses LPN 4, LPN 5, LPN 6, and LPN7 with reference to the correspondence information 5200 and may determine that mapping units respectively corresponding to the logical addresses LPN 4, LPN 5, LPN 6, and LPN7 are placed at page 3, based on the obtained physical address “1001”.

The controller 1420 may determine a final location of a mapping unit corresponding to a logical address by using the mapping function 5400. The mapping function 5400 may output information for determining one mapping unit of a plurality of mapping units present in a memory area indicated by the correspondence information 5200. For example, the controller 1420 may determine a bucket where a mapping unit corresponding to the received logical address is placed, based on the information output from the mapping function 5400.

According to an embodiment, the mapping function 5400 may be implemented with a hardware circuit such as a logic circuit. Alternatively, the mapping function 5400 may be implemented with a program code executable by the controller 1420. According to an embodiment, the mapping function 5400 implemented with the program code may be stored in a buffer memory connected with the controller 1420, a cache memory in the controller 1420, and the memory devices 1460.

The mapping function 5400 may generate information for determining a location of a mapping unit associated with an input key value. A key value that is generated based on the received logical address may be input to the mapping function 5400. For example, the mapping function 5400 may receive two or more bit values included in the received logical address as the key value. For example, the mapping function 5400 may receive a value, which is generated based on two or more bit values included in the received logical address (e.g., generated by combining two or more bits), as the key value.

The mapping function 5400 may map each of received logical addresses without collision with mapping units. That is, the mapping function 5400 may output different pieces of information with respect to different key values. For example, the mapping function 5400 may be a hashing function to perform a modulo operation. Alternatively, the mapping function 5400 may be a function corresponding to a combination of a plurality of hashing functions.

For example, the controller 1420 may determine that mapping units respectively corresponding to the logical addresses LPN 0, LPN 1, LPN 2, and LPN3 are placed at bucket #0, bucket #1, bucket #2, and bucket #3, respectively, based on the output information of the mapping function 5400. Also, the controller 1420 may determine that mapping units respectively corresponding to the logical addresses LPN 4, LPN 5, LPN 6, and LPN 7 are placed at bucket #4, bucket #5, bucket #6, and bucket #7, respectively, based on the output information of the mapping function 5400.

Finally, the controller 1420 may determine locations of mapping units respectively corresponding to the logical addresses LPN 0, LPN 1, LPN 2, and LPN3 as bucket #0 of page 0, bucket #1 of page 0, bucket #2 of page 0, and bucket #3 of page 0, respectively. Also, the controller 1420 may determine locations of mapping units respectively corresponding to the logical addresses LPN 4, LPN 5, LPN 6, and LPN 7 as bucket #0 of page 3, bucket #1 of page 3, bucket #2 of page 3, and bucket #3 of page 3, respectively.

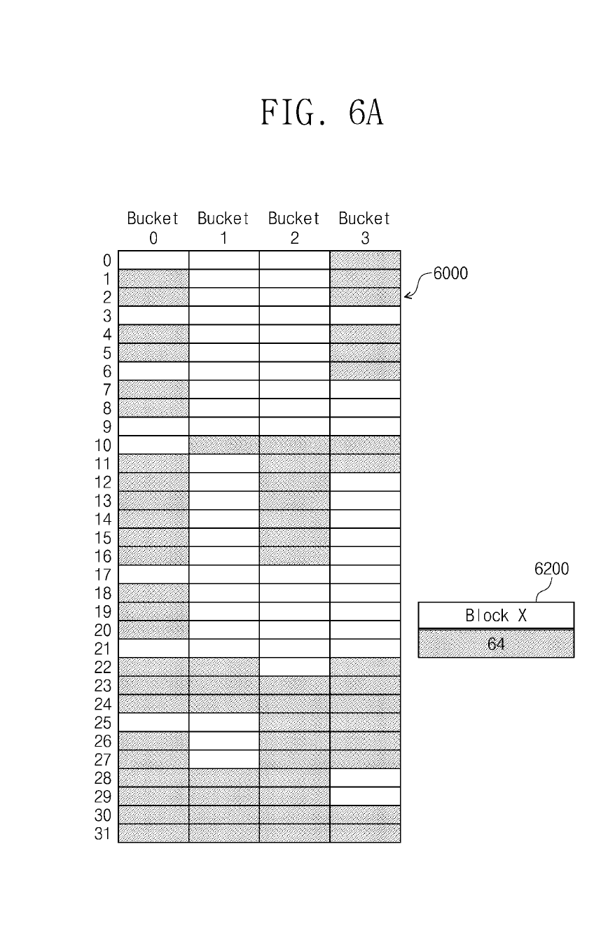

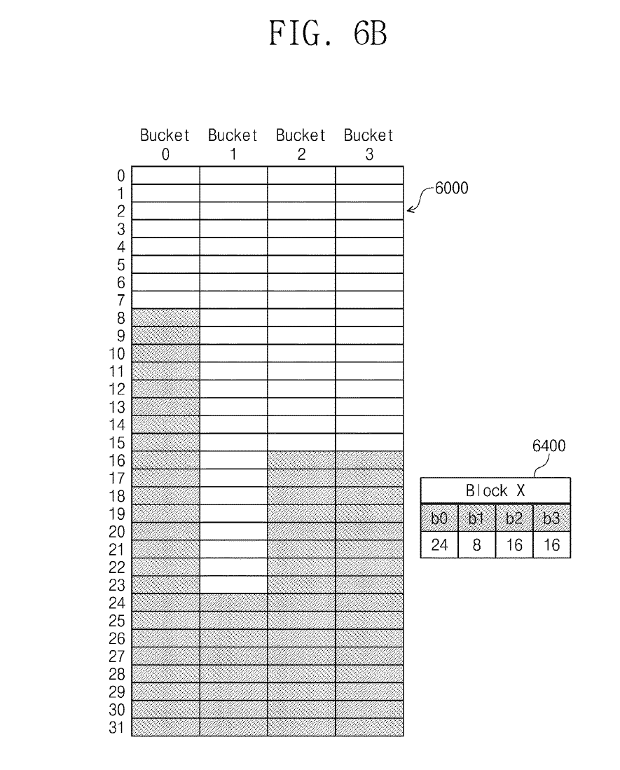

FIG. 6A illustrates a state where data are stored in a block, according to an embodiment.

As described above, the controller 1420 may determine a location (e.g., a specific bucket in a block) on the memory devices 1460, which corresponds to a mapping unit that a received logical address indicates, by using a mapping function.

A row of block X 6000 may indicate a page, and a column thereof may indicate a bucket. Block X 6000 according to an embodiment may be composed of 32 pages and may be divided into 4 buckets.

A shaded area may indicate a mapping unit where data are stored. For example, data are not stored in bucket #0 of a page having an index value of “0”, and data are stored in bucket #0 of a page having an index value of “2”. Below, a mapping unit where data are stored is referred to as a “valid mapping unit”.

The controller 1420 may perform an operation of making a free block (i.e., freeing a block) by selecting one of a plurality of blocks present in the memory devices 1460, moving data stored in the selected block to another block (i.e., a destination block), and erasing data previously stored in the selected block. The operation may be performed in the case where the storage device 1400 does not support in-place update of data. A block selected to move stored data to another block and erase the stored data may be referred to as a “victim block”.

The victim block may be selected in consideration of the amount of data on which a write operation will be performed. The amount of data on which a write operation will be performed may mean the amount of data on which a write operation will be performed practically to overwrite data on a block. For example, in the case where the storage device 1400 intends to overwrite data on a block, an operation of moving existing data stored in the block to another block may be performed prior to a write operation. Accordingly, to minimize overhead due to a write operation, there is a need to select a victim block capable of reducing the amount of data on which a write operation will be performed.

The controller 1420 according to an embodiment may select a block, of which the total number of valid mapping units is the smallest, as a victim block. To this end, the controller 1420 may determine information about the total number of valid mapping units with respect to each of a plurality of blocks of the memory devices 1460.

For example, the controller 1420 may recognize that 64 valid mapping units are present in the block X 6000, with reference to the information 6200 about the number of valid mapping units of the block X 6000.

FIG. 6B is a view indicating the number of valid mapping units for each bucket of a block illustrated in FIG. 6A.

The block X 6000 of FIG. 6B indicates the number of valid mapping units accumulated for each bucket without consideration of a physical location of a page, at which data are practically stored. Bucket #0, bucket #1, bucket #2, and bucket #3 of the block X 6000 include 24 valid mapping units, 8 valid mapping units, 16 valid mapping units, and 16 valid mapping units, respectively.

The controller 1420 may determine information 6400 about the number of valid mapping units for each bucket with respect to each of a plurality of blocks.

For example, to determine a victim block, the controller 1420 may refer to the information 6400 about the number of valid mapping units for each bucket of at least one block of a source block and a destination block.

That is, the controller 1420 may determine whether all data stored in the source block are once moved to the destination block, based on information about the number of valid mapping units for each bucket that are associated with at least one block of the source block and the destination block. The reason is that, since the storage device 1400 determines a location (e.g., a bucket), at which data will be stored, by using a mapping function, data stored in bucket #0 of the source block should be moved to bucket #0 of the destination block, data stored in bucket #1 of the source block to bucket #1 of the destination block, data stored in bucket #2 of the source block to bucket #2 of the destination block, and data stored in bucket #3 of the source block to bucket #3 of the destination block.

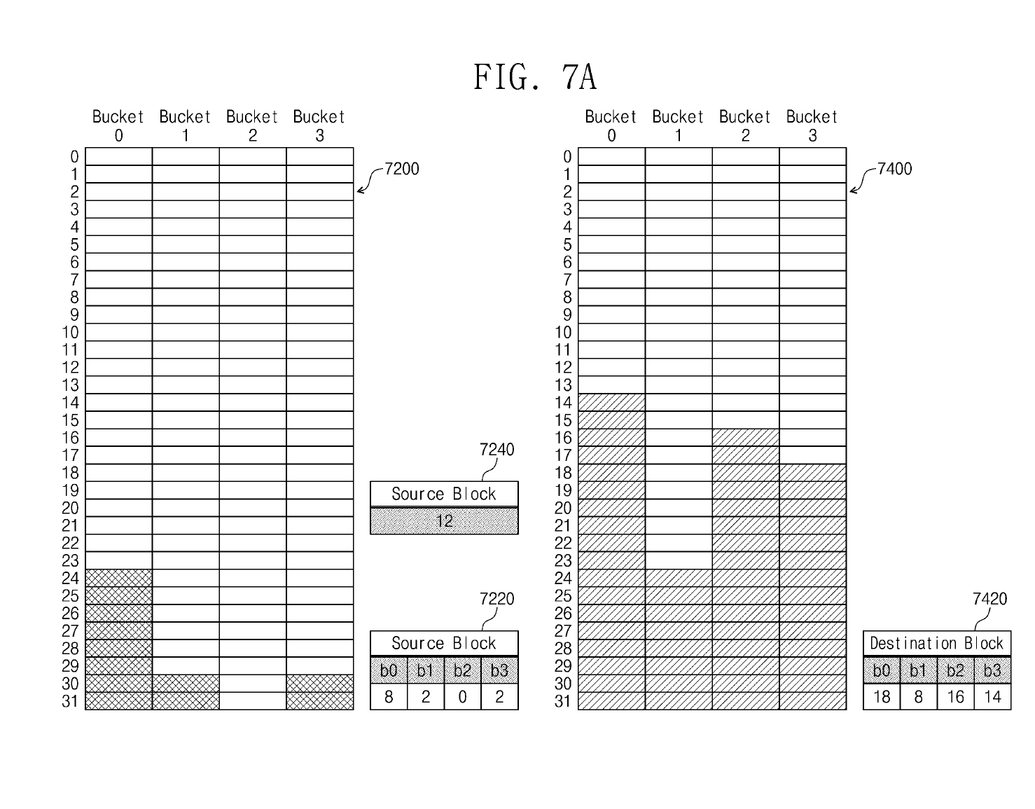

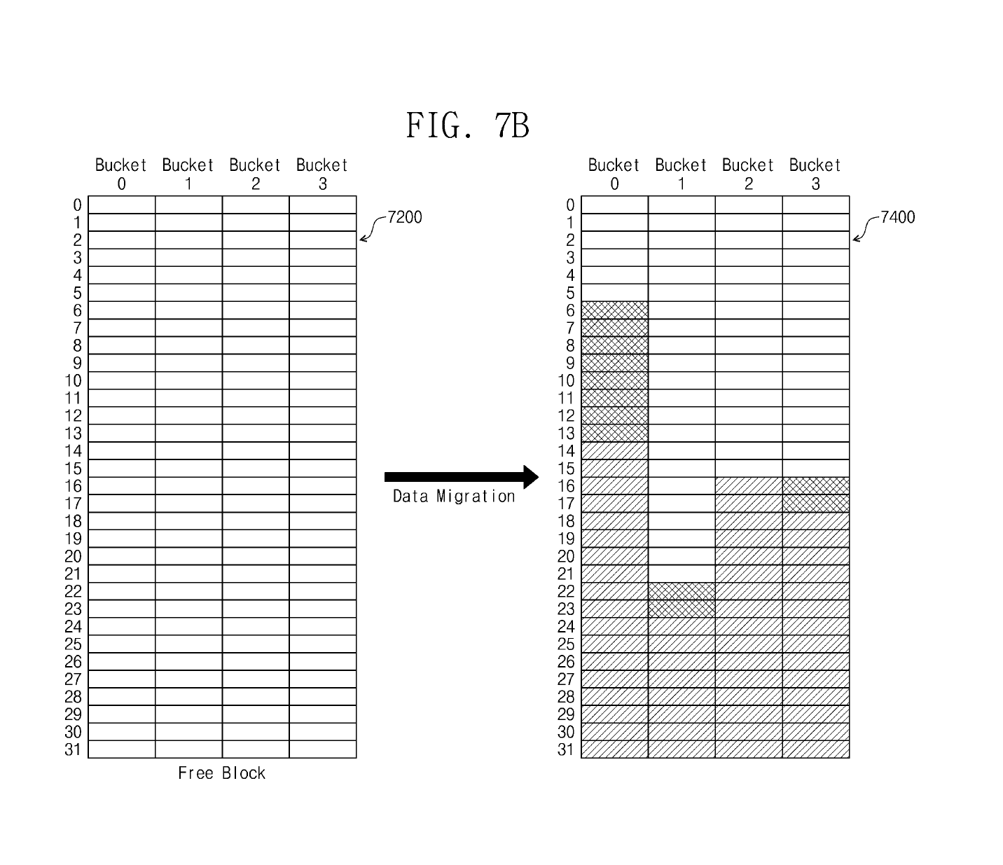

FIG. 7A illustrates data store states of a source block and a destination block according to an embodiment.

A valid mapping unit of a source block 7200 is marked by a check pattern, and a valid mapping unit of a destination block 7400 is marked by a diagonal line.

The controller 1420 according to an embodiment may determine a victim block with reference to information 7420 about the number of valid mapping units for each bucket in the destination block 7400.

The controller 1420 may recognize that 18 valid mapping units, 8 valid mapping units, 16 valid mapping units, and 14 valid mapping units are present in bucket #0, bucket #1, bucket #2, and bucket #3 of the destination block 7400, respectively. In other words, 14 empty mapping units capable of storing data are present in bucket #0, 24 empty mapping units in bucket #1, 16 empty mapping units in bucket #2, and 18 empty mapping units in bucket #3. That is, the controller 1420 may obtain information (e.g., index information of a bucket) about a bucket, which has the smallest space for storing data, with reference to the information 7420 about the number of valid mapping units for each bucket in the destination block 7400.

Bucket #0 of the destination block 7400 may be a bucket that has the smallest space for storing data. In the case of moving data of the source block 7200 to the destination block 7400, the controller 1420 may in advance determine whether the source block 7200 changes to a free block (i.e., whether all data of the source block 7200 are once moved to the destination block 7400).

For example, the controller 1420 may compare the total number of valid mapping units of the source block 7200 with a free storage space of a bucket having the smallest space among a plurality of buckets of the destination block 7400 and may determine whether all pieces of data of the source block 7200 are able to be moved to the destination block 7400, depending on the comparison result. For example, if the total number of valid mapping units of the source block 7200 (e.g., 12 obtained from the information 7240 about the total number of valid mapping units) is smaller than the number (e.g., 14) of empty mapping units of bucket #0 in the destination block 7400, the controller 1420 may in advance determine that the source block 7200 is able to change to a free block in the case of moving data of the source block 7200 to the destination block 7400.

In this case, the controller 1420 may determine the source block 7200 as a victim block without consideration of the information 7220 about the number of valid mapping units for each bucket in the source block 7200.

FIG. 7B indicates states of a source block and a destination block after data migration from the source block to the destination block of FIG. 7A is made.

After data migration is made, the source block 7200 changes to a free block, and new data moved from the source block 7200 for each bucket are stored in the destination block 7400.

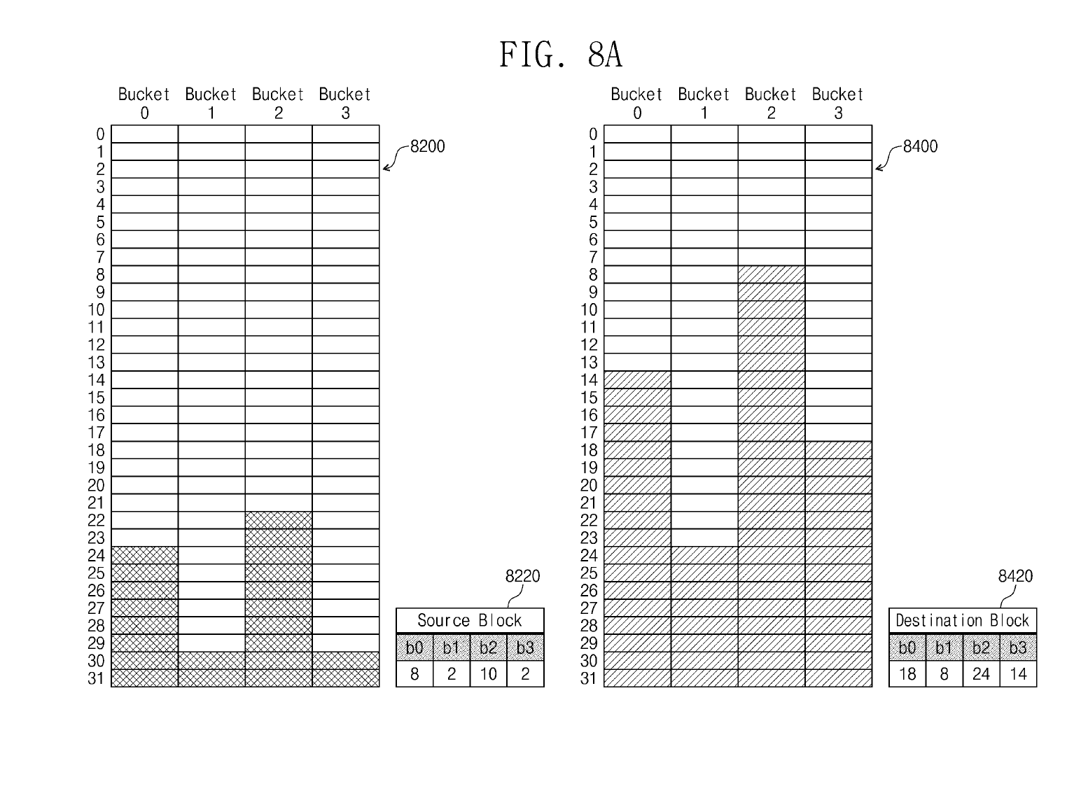

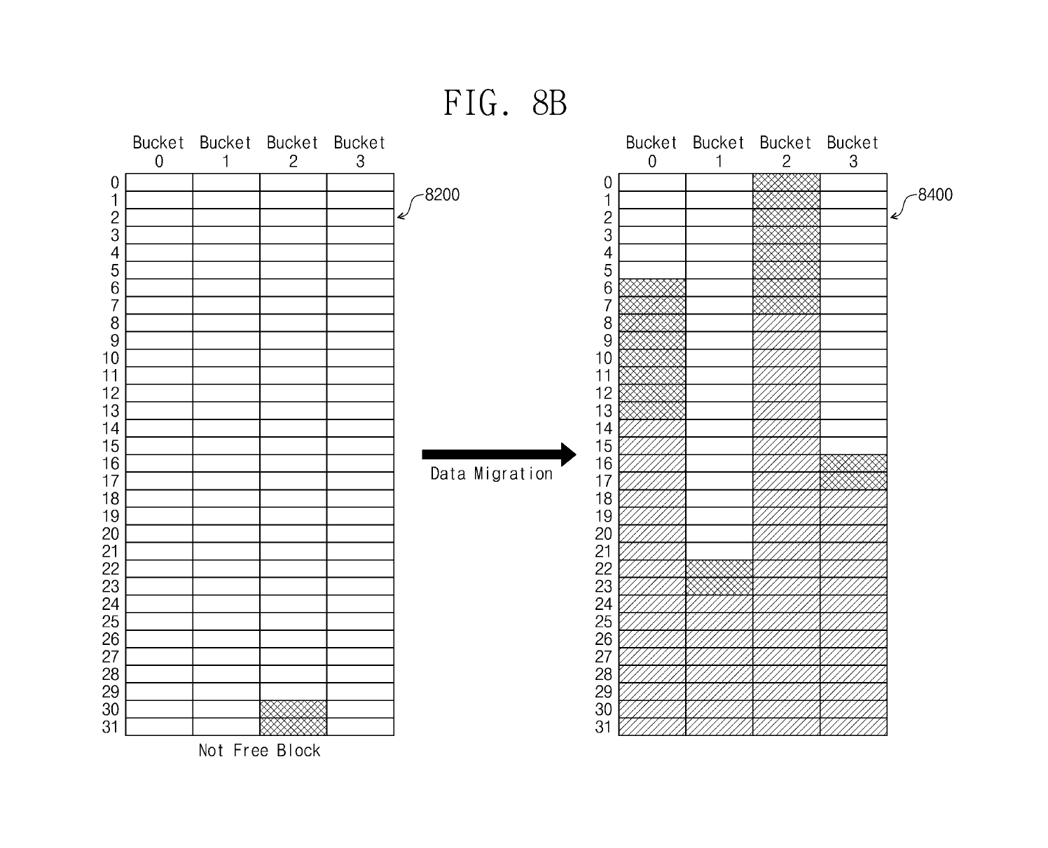

FIG. 8A illustrates data store states of a source block and a destination block according to another embodiment.

A valid mapping unit of a source block 8200 is marked by a check pattern, and a valid mapping unit of a destination block 8400 is marked by a diagonal line.

8 valid mapping units, 2 valid mapping units, 10 valid mapping units, and 2 valid mapping units are present in bucket #0, bucket #1, bucket #2, and bucket #3 of the source block 8200, respectively. Also, 18 valid mapping units, 8 valid mapping units, 24 valid mapping units, and 14 valid mapping units are present in bucket #0, bucket #1, bucket #14, and bucket #3 of the destination block 8400, respectively.

To determine a victim block, the controller 1420 according to an embodiment may obtain information about a bucket (i.e., bucket #2), of which the number of empty mapping units is the smallest, based on information 8420 about the number of valid mapping units for each bucket in the destination block 8400. Eight empty mapping units capable of storing data are present in bucket #2 of the destination block 8400. In this case, the controller 1420 may determine, as a victim block, a block where the number of valid mapping units of a bucket having the same identifier as an identifier of a bucket, of which the number of empty mapping units is the smallest in the destination block 8400, is the smallest.

For example, it is assumed that the controller 1420 considers the source block 8200 as a candidate of a victim block. Referring to information 8220 about the number of valid mapping units for each bucket in the source block 8200, the number of valid mapping units present in bucket #2 of the source block 8200 is 10.

FIG. 8B indicates states of a source block and a destination block after data migration from the source block to the destination block of FIG. 8A is made.

New data moved from the source block 8200 for each bucket are stored in the destination block 8400. Since two valid mapping blocks are still present in bucket #2 of the source block 8200 after data migration is made, the source block 8200 is not a free block. Accordingly, in this case, the controller 1420 should move data remaining in the source block 8200 to a new destination block.

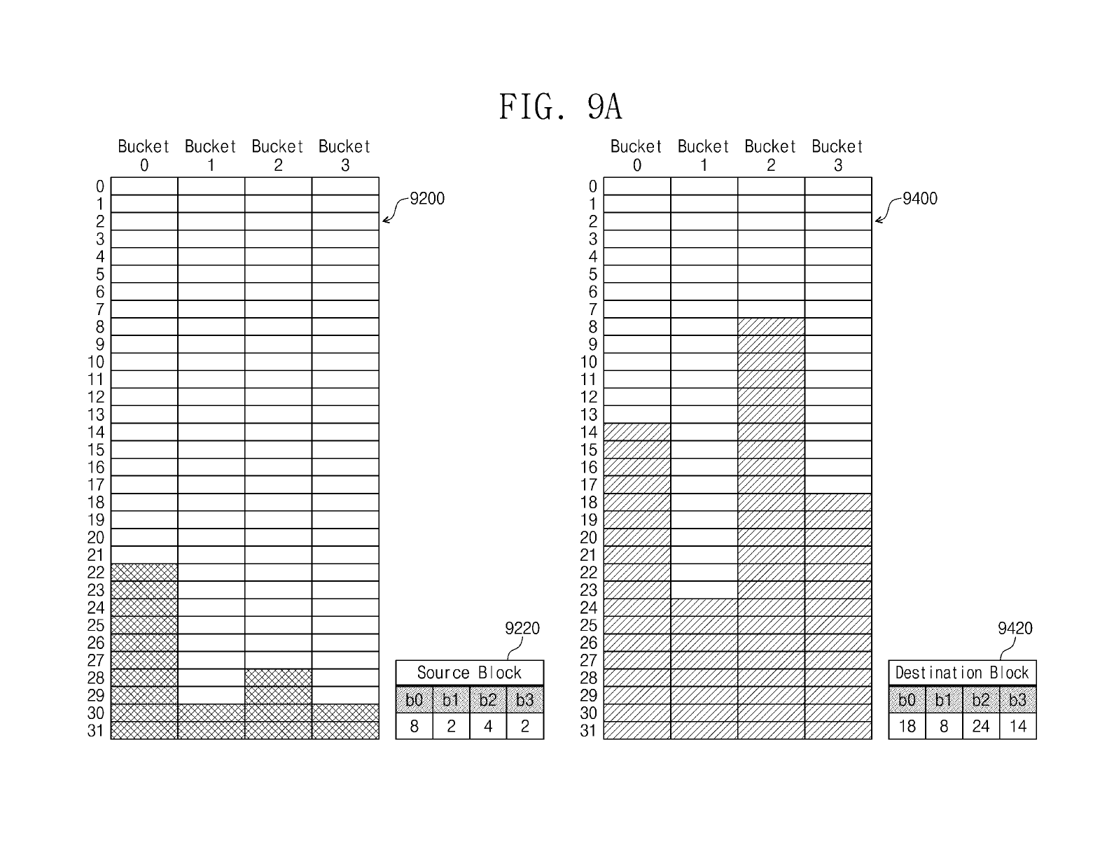

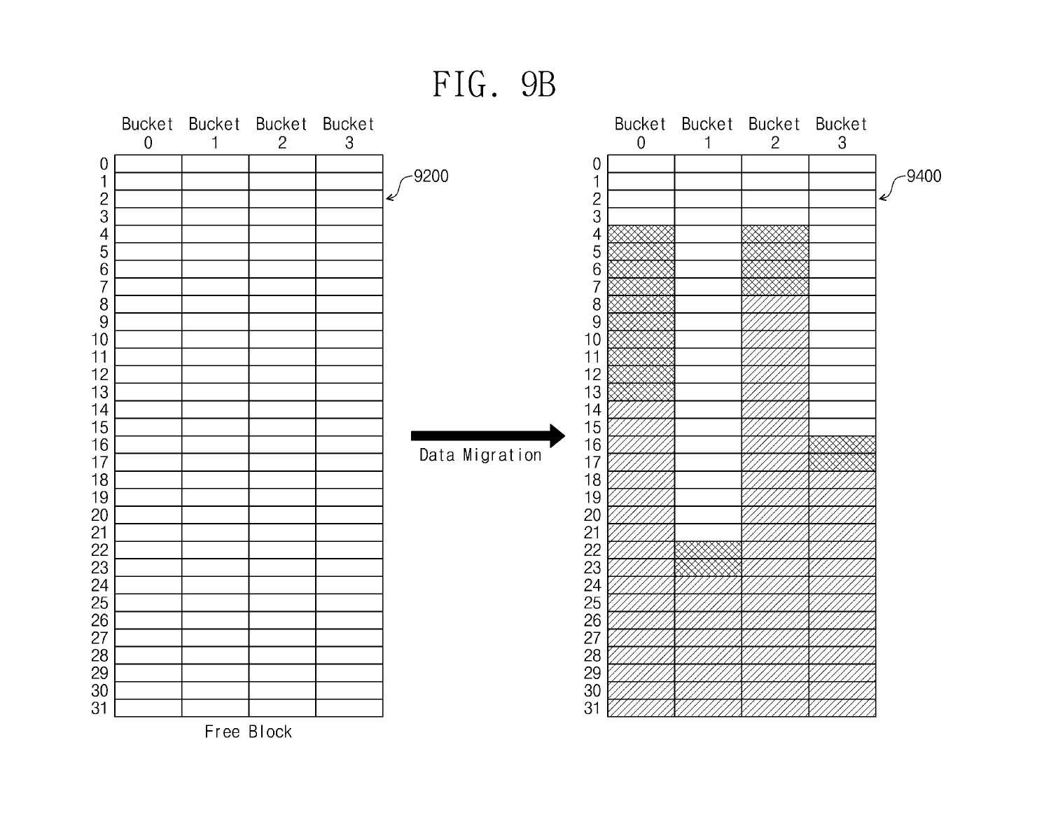

Accordingly, with regard to bucket #2, if another block, of which the number of valid mapping units is smaller than that of the source block 8200, exists, the controller 1420 may select such block as a victim block to reduce overhead due to a write operation. The case where another block, of which the number of valid mapping units is smaller than that of the source block 8200, exists with regard to bucket #2 is described with reference to FIGS. 9A and 9B.

FIG. 9A illustrates data store states of a source block and a destination block and information about the number of valid mapping units for each bucket, according to another embodiment.

A valid mapping unit of a source block 9200 is marked by a check pattern, and a valid mapping unit of a destination block 9400 is marked by a diagonal line.

In FIG. 9A, information 9220 indicates that 8 valid mapping units, 2 valid mapping units, 4 valid mapping units, and 2 valid mapping units are present in bucket #0, bucket #1, bucket #2, and bucket #3 of the source block 9200, respectively. In FIG. 9A, information 9420 indicates that 18 valid mapping units, 8 valid mapping units, 24 valid mapping units, and 14 valid mapping units are present in bucket #0, bucket #1, bucket #14, and bucket #3 of the destination block 9400, respectively.

As described above, the controller 1420 may determine that a bucket of the destination block 9400, of which the number of mapping units capable of storing data is the smallest is bucket #2. The controller 1420 may select a block, of which the number of valid mapping units in bucket #2 is the smallest, from among a plurality of blocks as the source block 9200. Four valid mapping units are present in bucket #2 of the source block 9200.

FIG. 9B indicates states of a source block and a destination block after data migration from the source block to the destination block of FIG. 9A is made.

New data moved from the source block 9200 are stored in the destination block 9400 for each bucket. Since all data stored in the source block 9200 migrate to the destination block 9400, the source block 9200 changes to a free block.

The method of selecting a victim block, which is described with reference to FIGS. 7A and 9B, is only an embodiment of a method of determining a victim block in consideration of a distribution of valid mapping units for each bucket of each block, and the disclosure is not limited thereto. Accordingly, in the storage device 1400 where an area (e.g., a bucket) in a block, in which data are stored, is determined by using a mapping function, any algorithm for selecting a victim block in consideration of a distribution of valid mapping units for each bucket (e.g., information about the number of valid mapping units for each bucket) may be adopted.

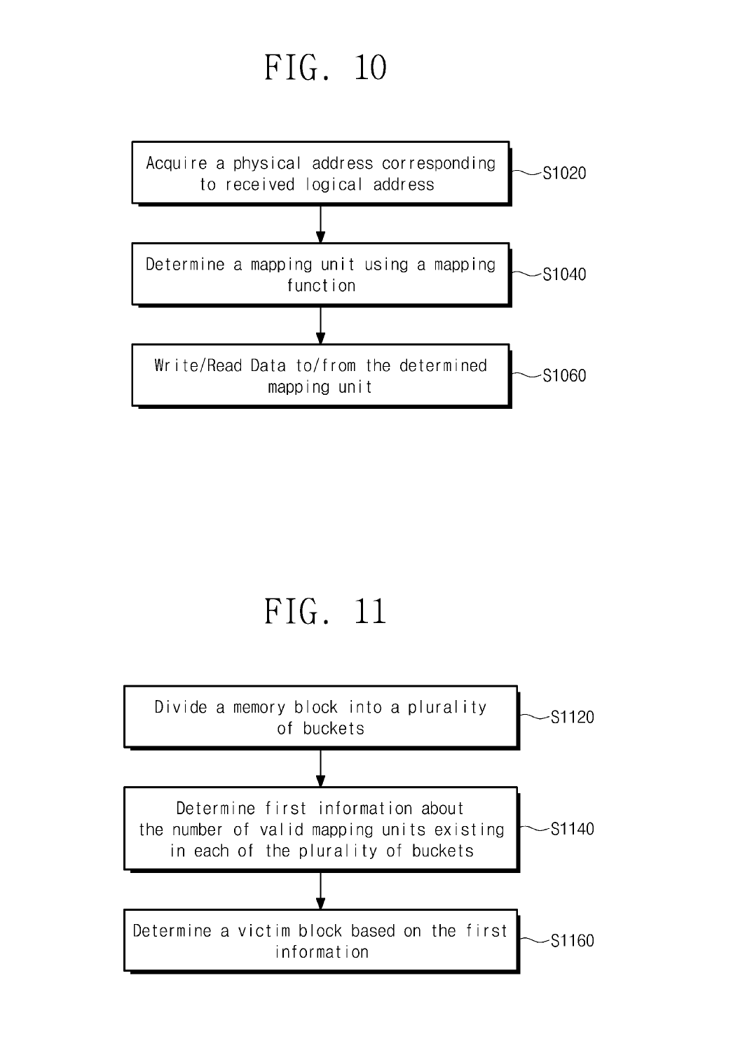

FIG. 10 illustrates a flowchart of a method for operating a storage device according to an embodiment.

In operation S1020, the storage device 1400 may obtain a physical address corresponding to a logical address received from the host 1200 with reference to correspondence information indicating a correspondence relationship between logical addresses and physical addresses. According to an embodiment, the correspondence information may manage a physical address, the size of which is smaller than a physical address managed in a full mapping table. For example, in the case where the size of a physical address needed to indicate a mapping unit is “N” bits (N being a positive integer), a physical address managed in the correspondence information may have the size of “N−M” bits (M being a positive integer smaller than N). The storage device 1400 may determine a partial memory area in the storage device 1400 indicated by the obtained physical address. Here, “M” may be differently determined according to the degree for reducing a memory that the correspondence information occupies. As an embodiment, “M” may be a value that is determined in a design or manufacturing step (e.g., before operation S1020) of the storage device 1400 in consideration of a capacity of a buffer, a cache memory, and the memory devices 1460 in the storage device 1400. As another embodiment, “M” may be a value that flexibly varies with a state of the storage device 1400. For example, “M” may be determined to be small if a buffer memory or a cache memory in the storage device 1400 is sufficient and may be determined to be great if not.

In operation S1040, the storage device 1400 may determine a mapping unit corresponding to the received logical address, by using a mapping function. The storage device 1400 may obtain information for determining a location of a mapping unit corresponding to the received logical address from the mapping function. The mapping function according to an embodiment may be a hashing function for mapping each of received logical addresses without collision with mapping units. The mapping function may output information for determining one area of 2^{M} areas (e.g., buckets), at which mapping units are able to be placed, depending on a value of “M”. A key value to be input to the mapping function may be generated based on the received logical address. For example, the mapping function may receive two or more bit values included in the received logical address as the key value and may output information for determining a location of a mapping unit through conversion of the received key value. For example, the key value may be generated based on two or more bit values (e.g., by combining two or more bit values). The storage device 1400 may finally determine a location of a mapping unit corresponding to the received logical address. The storage device 1400 may determine one mapping unit of a plurality of mapping units placed in the partial memory area determined in operation S1020, based on the information output from the mapping function.

In operation S1060, the storage device 1400 may read or write data from or in the mapping unit determined in operation S1040.

FIG. 11 illustrates a flowchart of a method for operating a storage device according to an embodiment.

In operation S1120, the storage device 1400 may divide each of a plurality of memory blocks into a plurality of buckets based on an output of a mapping function used in the storage device 1400. As an embodiment, the storage device 1400 may manage information about buckets respectively corresponding to outputs of the mapping function together with identifiers of the buckets, from a point in time to manufacture the storage device 1400. As another embodiment, when it is determined that a victim block is necessary, the storage device 1400 may divide each of a plurality of memory blocks into buckets respectively corresponding to the outputs of the mapping function. For example, the storage device 1400 may generate and initialize an array or a linked list corresponding to each bucket.

In operation S1140, the storage device 1400 may determine information (information about the number of valid mapping units for each bucket) indicating the number of valid mapping units present in each of a plurality of buckets, with respect to each of the plurality of memory blocks. The information about the number of valid mapping units for each bucket is described with reference to FIGS. 6A to 9B.

In operation S1160, the storage device 1400 may determine a victim block based on the information about the number of valid mapping units for each bucket determined in operation S1140. The storage device 1400 may determine whether all data stored in a source block are once moved to a destination block (i.e., moved to a single destination block), for the purpose of determining a victim block. To this end, the storage device 1400 may refer to information about the number of valid mapping units for each bucket, associated with at least one block of a source block and a destination block.

As the first embodiment, the storage device 1400 may select a block, of which the total number of valid mapping units is the smallest, as a source block being a candidate of a victim block. The storage device 1400 may determine whether all data of the selected source block are able to migrate to one destination block, with reference to information about the number of valid mapping units for each bucket of a destination block and information about the total number of valid mapping units of a source block. If the determination result indicates that the source block is able to change to a free block after data migration, the storage device 1400 may determine the source block as a victim block without reference to information about the number of valid mapping units for each bucket of the source block. The first embodiment is described above with reference to FIGS. 7A and 7B.

As the second embodiment, the storage device 1400 may select a bucket, of which the number of empty mapping units is the smallest, with reference to information about the number valid mapping units for each bucket of a destination block. The storage device 1400 may select a block, in which the number of valid mapping units present in a bucket having the same identifier as the selected bucket is the smallest, as a victim block. In this case, information about the number of valid mapping units for each bucket of a source block may be referenced. The second embodiment is described above with reference to FIGS. 8A to 9B.

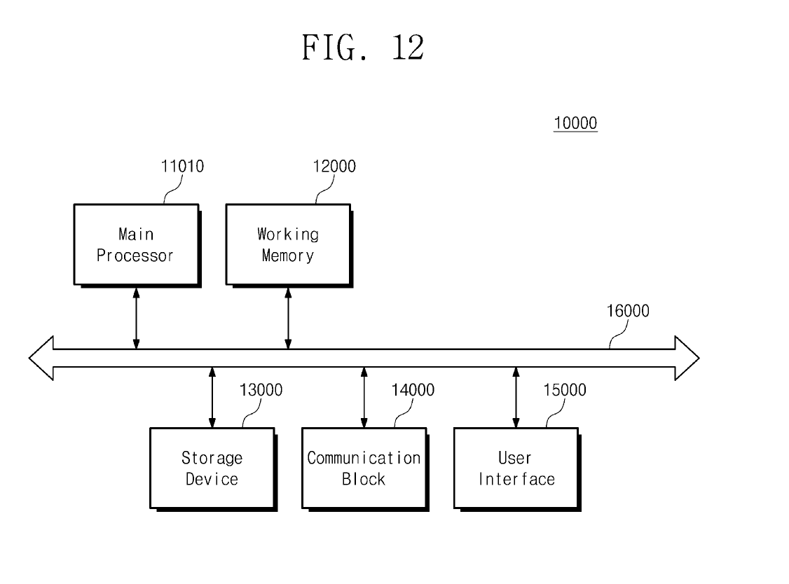

FIG. 12 is a block diagram illustrating an exemplary configuration of an electronic system including a storage device according to an embodiment.

An electronic system 10000 may include a main processor 11010, a working memory 12000, a storage device 13000, a communication block 14000, a user interface 15000, and a bus 16000. For example, the electronic system 10000 may be one of electronic devices such as a desktop computer, a laptop computer, a tablet computer, a smartphone, a wearable device, a video game console, a workstation, a server, and an electric vehicle. The electronic system 10000 according to an embodiment may include any one of the electronic devices described above with reference to FIGS. 1 to 9B. For example, the electronic system 10000 may include the electronic device 1000 of FIG. 1 but is not limited thereto.

The main processor 11010 may control overall operations of the electronic system 10000. The main processor 11010 may process various kinds of arithmetic operations and/or logical operations. To this end, the main processor 11010 may include a special-purpose logic circuit (e.g., a field programmable gate array (FPGA) or application specific integrated chips (ASICs)). For example, the main processor 11010 may include one or more processor cores and may be implemented with a general-purpose processor, a special-purpose processor, or an application processor. The main processor 11010 may include the host 1200 of FIG. 1. For example, the main processor 11010 may send a write or read command to the storage device 13000 together with a logical address.

The working memory 12000 may store data to be used in an operation of the electronic system 10000. For example, the working memory 12000 may temporarily store data that are processed or will be processed by the main processor 11010. The working memory 12000 may include a volatile memory, such as a dynamic random access memory (DRAM), a synchronous DRAM (SDRAM), or the like, and/or a nonvolatile memory, such as a phase-change RAM (PRAM), a magneto-resistive RAM (MRAM), a resistive RAM (ReRAM), a ferroelectric RAM (FRAM), or the like.

The storage device 13000 may include at least one memory device and a controller. The memory device of the storage device 13000 may store data regardless of power supply. For example, the storage device 13000 may include a nonvolatile memory device such as a flash memory, a PRAM, an MRAM, a ReRAM, a FRAM, or the like. For example, the storage device 13000 may include a storage medium such as a solid state drive (SSD), card storage, embedded storage, or the like.

The storage device 13000 according to an embodiment may perform the mapping method described above with reference to FIGS. 1 to 5. For example, the storage device 13000 may include the storage device 1400 of FIG. 5 but is not limited thereto. For example, the storage device 13000 may receive a logical address from the main processor 11010 and may determine a mapping unit corresponding to the received logical address by using mapping information in the storage device 13000. The mapping information may include correspondence information indicating a correspondence relationship between logical addresses and physical addresses and a mapping function capable of outputting information about a location of a mapping unit. For example, the correspondence information managed in the storage device 13000 may include the correspondence information 5200 of FIG. 5, and the mapping function may include the mapping function 5400 of FIG. 5.

Also, the storage device 13000 according to an embodiment may determine a victim block by using the method described above with reference to FIGS. 6A to 9B. For example, the storage device 13000 may determine information about the number of valid mapping units for each bucket, with regard to each block. For example, the storage device 13000 may determine a victim block capable of minimizing overhead due to a write operation with reference to information about the number of valid mapping units for each bucket determined for each block.

The communication block 14000 may communicate with an external device/system of the electronic system 10000. For example, the communication block 14000 may support at least one of various wireless communication protocols such as long term evolution (LTE), worldwide interoperability for microwave access (WiMax), global system for mobile communication (GSM), code division multiple access (CDMA), Bluetooth, near field communication (NFC), and wireless fidelity (Wi-Fi), radio frequency identification (RFID) and/or at least one of various wired communication protocols such as transfer control protocol/Internet protocol (TCP/IP), universal serial bus (USB), and Firewire.

The user interface 15000 may perform communication arbitration between a user and the electronic system 10000. For example, the user interface 15000 may include input interfaces such as a keyboard, a mouse, a keypad, a button, a touch panel, a touch screen, a touch pad, a touch ball, a camera, a microphone, a gyroscope sensor, and a vibration sensor. For example, the user interface 15000 may include output interfaces such as a liquid crystal display (LCD) device, a light emitting diode (LED) display device, an organic LED (OLED) display device, an active matrix OLED (AMOLED) display device, a speaker, and a motor.

The bus 16000 may provide a communication path between the components of the electronic system 10000. The components of the electronic system 10000 may exchange data with each other based on a bus format of the bus 16000. For example, the bus format may include one or more of various interface protocols such as USB, small computer system interface (SCSI), peripheral component interconnect express (PCIe), mobile PCIe (M-PCIe), advanced technology attachment (ATA), parallel ATA (PATA), serial ATA (SATA), serial attached SCSI (SAS), integrated drive electronics (IDE), enhanced IDE (EIDE), nonvolatile memory express (NVMe), and universal flash storage (UFS).

Meanwhile, the memory mapping method and the victim block determining method, which are described above, may be implemented in a computer-readable recording medium as a program or codes which a computer can read out. The computer-readable recording medium may include all kinds of storage devices in which data are stored. Examples of the computer-readable recording medium include read-only memories (ROMs), random-access memories (RAMs), CD-ROMs, magnetic tapes, floppy disks, optical data storage devices, and carrier waves (such as data transmission through the Internet). Also, in the computer-readable recording medium, a program or codes, which a computer can read out, may be stored and executed in a distributed manner.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The above descriptions are intended to provide exemplary configurations and operations for implementing the disclosure. The scope and spirit of the disclosure may include implementations capable of being obtained by changing or modifying simply the above embodiments, in addition to the above-described embodiments. Also, the scope and spirit of the disclosure may include implementations capable of being accomplished by changing or modifying the above-described embodiments afterwards easily.

1. A storage device comprising:
a memory device; and
a controller that translates a logical address received from a host into a physical address for the memory device, wherein:
the controller manages correspondence information, indicating a correspondence relationship between logical addresses and physical addresses, and a mapping function for determining a mapping unit corresponding to the logical address in a partial memory area on the memory device indicated by a physical address managed in the correspondence information,
the mapping unit corresponding to the logical address is an area on the memory device indicated by the logical address, and
the controller determines the partial memory area, including the mapping unit corresponding to the logical address, with reference to the correspondence information and determines the mapping unit from the partial memory area by using the mapping function.

2. The storage device of claim 1, wherein a size of the physical address managed in the correspondence information is smaller than a size of a physical address indicating the mapping unit.

3. The storage device of claim 2, wherein:
the physical address managed in the correspondence information has “M” (M being a positive integer) fewer bits than the number of bits of the physical address indicating the mapping unit,
the partial memory area on the memory device indicated by the physical address managed in the correspondence information includes 2^{M} mapping units, and
the controller uses the mapping function to determine one mapping unit of the 2^{M} mapping units as the mapping unit corresponding to the logical address.

4. The storage device of claim 1, wherein the controller:
obtains a physical address corresponding to the logical address with reference to the correspondence information;
determines the partial memory area indicated by the physical address; and
determines a location of the mapping unit corresponding to the logical address in the partial memory area, by using the mapping function.

5. The storage device of claim 1, wherein the mapping function outputs information for determining a location of the mapping unit corresponding to the logical address in the partial memory area, based on two or more bit values included in the logical address.

6. The storage device of claim 5, wherein:
the two or more bit values are used as a key value in the mapping function, and
the mapping function is a hashing function for outputting different information with respect to different key values.

7. The storage device of claim 1, wherein:
the controller:
divides each of a plurality of memory blocks included in the memory device into a plurality of buckets based on an output of the mapping function; and
determines a victim block of the plurality of memory blocks based on a number of valid mapping units of each of the plurality of buckets, and each of the valid mapping units is a mapping unit where data are stored.

8. The storage device of claim 7, wherein the controller:
selects a memory block having a smallest total number of the valid mapping units, from among the plurality of memory blocks, based on a total number of valid mapping units of each of the plurality of memory blocks, the selected memory block constituting a source block that is a candidate for the victim block; and
determines the source block to be the victim block based on a number of valid mapping units of a destination block.

9. The storage device of claim 8, wherein the controller:
selects a bucket having a smallest number of empty mapping units, from among a plurality of buckets of the destination block, based on the number of valid mapping units of the destination block; and
determines the source block as the victim block depending on a result of comparing the number of empty mapping units of the selected bucket and a total number of valid mapping units of the source block.

10. The storage device of claim 7, wherein the controller:
selects a bucket having a smallest number of empty mapping units, from among a plurality of buckets of a destination block, based on a number of valid mapping units of the destination block; and
determines a memory block, from among the plurality of memory blocks, having a smallest number of valid mapping units present in a bucket with a same identifier as the selected bucket to be the victim block based on a number of valid mapping units of each of the plurality of memory blocks.

11. A method for operating a storage device, the method comprising:
obtaining a physical address corresponding to a logical address received from a host, based on correspondence information indicating a correspondence relationship between logical addresses and physical addresses;
determining a mapping unit corresponding to the logical address in a partial memory area on a memory device indicated by the physical address, by using a mapping function; and
reading or writing data from or in the mapping unit, wherein
the mapping unit corresponding to the logical address is included in the partial memory area.

12. The method of claim 11, wherein a size of the physical address managed in the correspondence information is smaller than a size of a physical address indicating a location of the mapping unit.

13. The method of claim 12, wherein:
the physical address managed in the correspondence information has “M” (M being a positive integer) fewer bits than the number of bits of the physical address indicating the location of the mapping unit,
the partial memory area indicated by the physical address managed in the correspondence information includes 2^{M} mapping units, and
the mapping function outputs information for determining one mapping unit of the 2^{M} mapping units.

14. The method of claim 11, wherein the determining of the mapping unit includes:
inputting two or more bit values included in the logical address to the mapping function as a key value; and
outputting information for determining a location of the mapping unit based on the key value in the mapping function.

15. The method of claim 14, wherein the mapping function is a hashing function for outputting different information with respect to different key values.

16. A storage device comprising:
a memory device; and
a controller that translates a logical address received from a host into a physical address for the memory device, wherein:
the controller manages correspondence information, indicating a correspondence relationship between logical addresses and physical addresses, and a mapping function for determining a mapping unit corresponding to the logical address in a partial memory area on the memory device indicated by a physical address managed in the correspondence information,
the mapping unit corresponding to the logical address is an area on the memory device indicated by the logical address,
a physical address managed in the correspondence information has “M” (M being a positive integer) fewer bits than the number of bits of a physical address indicating the mapping unit,
the partial memory area on the memory device indicated by the physical address managed in the correspondence information includes 2^{M} mapping units, and
the controller uses the mapping function to determine one mapping unit of the 2^{M} mapping units as the mapping unit corresponding to the logical address.

17. The storage device of claim 16, wherein, if each of a plurality of memory blocks included in the memory device is composed of 2^{K} pages (K being a positive integer), the controller determines “M” to be smaller than “K”.

18. The storage device of claim 16, wherein the mapping function receives a key value generated by combining two or more bit values included in the logical address and hashes the key value to output information for determining a location of the mapping unit corresponding to the logical address in the partial memory area.

19. The storage device of claim 18, wherein the mapping function is a hashing function for outputting different information with respect to different key values.

20. The storage device of claim 18, wherein the information for determining the location of the mapping unit includes bits for determining one area of 2^{M} areas constituting a memory block.

21-29. (canceled)
